(19) United States
(12) Patent Application Publication
(10) Pub. No.: US 2016/0167699 A1
(43) Pub. Date: Jun. 16, 2016

(54) VEHICLE CONTROL APPARATUS

(71) Applicant: HITACHI AUTOMOTIVE SYSTEMS, LTD., Ibaraki (JP)

(72) Inventor: Naoshi YAMAGUCHI, Yamato-shi, Kanagawa (JP)

(73) Assignee: HITACHI AUTOMOTIVE SYSTEMS, LTD., Hitachinaka-shi, Ibaraki (JP)

(21) Appl. No.: 14/904,216

(22) PCT Filed: Jul. 16, 2014
(86) PCT No.: PCT/JP2014/068901

§ 371 Date: Jan. 11, 2016

(30) Foreign Application Priority Data
Jul. 17, 2013 (JP) 2013-148678

(51) Int. Cl. B62D 5/04

(52) U.S. Cl. CPC B62D 5/049

(57) ABSTRACT

Detection of any fault in the gain of output of a yaw rate sensor is determined as possible if an amount of change in the gain of a yaw rate detected by a yaw rate sensor relative to a yaw rate calculated from a steering angle detected by a steering angle sensor is lower than or equal to a predetermined value. If the detection of any fault in the gain of output of the yaw rate sensor is determined as possible, detection of any fault in the gain of output of the yaw rate sensor is performed.

### TECHNICAL FIELD

The present invention relates to a vehicle control apparatus.

### BACKGROUND ART

As an example of this technical field, Patent Document 1, listed below, discloses a technique for determining whether or not each sensor is failing when the grip of the tires of a moving vehicle is in a linear region.

### CITATION LIST

### Patent Literature

Patent Document 1: Japanese Patent Public Disclosure No. 2002-053024

### SUMMARY OF THE INVENTION

### Problem to be Solved by the Invention

The above-described technique, however, determines correlation from a difference in yaw rate on the basis of the output from each sensor when the grip of the tires of the vehicle while moving is in a linear region. This leaves the possibility of incorrectly recognizing a sensor as failing when the situation occurs where it is temporarily impossible to determine whether the grip of the tires while the vehicle is running is in a non-linear region or a linear region.

The present invention is made to solve this problem. The object of the present invention is to provide a vehicle control apparatus that prevents incorrect detection of sensor failure in a sensor failure diagnosis while the vehicle is running on a surface, typically that of a road of low μ, where the grip of the tires falls in a non-linear region, or while the vehicle is running on a bank.

### Solution to Problem

To achieve the above-described object, the vehicle control apparatus of the present invention determines detection of any fault in the gain of the output of a yaw rate sensor as possible if an amount of change in the gain of a yaw rate detected by the yaw rate sensor, relative to a yaw rate calculated from steering angle detected by a steering angle sensor, is lower than or equal to a predetermined value, and detects any fault in the gain of the output of the yaw rate sensor if detection of any fault in the gain of the output from the yaw rate sensor is determined as possible.

### Effect of the Invention

The present invention prevents incorrectly identifying a sensor as failing when the grip of the tires of a moving vehicle is in a non-linear region.

### BRIEF DESCRIPTION OF THE DRAWINGS

FIG. 1 is a block diagram of a processing unit for gain fault determination according to a first embodiment.

FIG. 2 is a state transition diagram of a moving-direction determination unit according to the first embodiment.

FIG. 3 is a state transition diagram of a turning-direction determination unit according to the first embodiment.

FIG. 4 is a state transition diagram of a gain reference calculation unit according to the first embodiment.

FIG. 5 is a state transition diagram of a processing unit for gain fault determination according to the first embodiment.

FIG. 6 is a time chart of the gain of a yaw rate detected, relative to a yaw rate calculated from steering angle, according to the first embodiment.

FIG. 7 is a time chart of the gain of a yaw rate detected, relative to a yaw rate calculated from steering angle, according to the first embodiment.

FIG. 8 is a time chart of a yaw rate calculated from a steering angle, a yaw rate detected, and a yaw rate calculated from a lateral acceleration, according to the first embodiment.

FIG. 9 is a graph showing changes of a yaw rate detected, relative to a yaw rate calculated from steering angle, according to the first embodiment.

FIG. 10 is a graph showing changes of a yaw rate calculated from lateral acceleration relieve to a yaw rate calculated from steering angle, according to the first embodiment.

### REFERENCE NUMERALS

2. steering angle sensor
3. lateral acceleration sensor
7. yaw rate sensor
9. moving-direction determination unit (longitudinal-movement detection unit)
10. turning-direction determination unit
12. gain fault determination unit (unit for detection of fault in yaw rate sensor output gain, unit for detection of fault in lateral acceleration output gain, detection determination unit, and unit for detection of output gain fault)

### Embodiments of the Invention

### First Embodiment

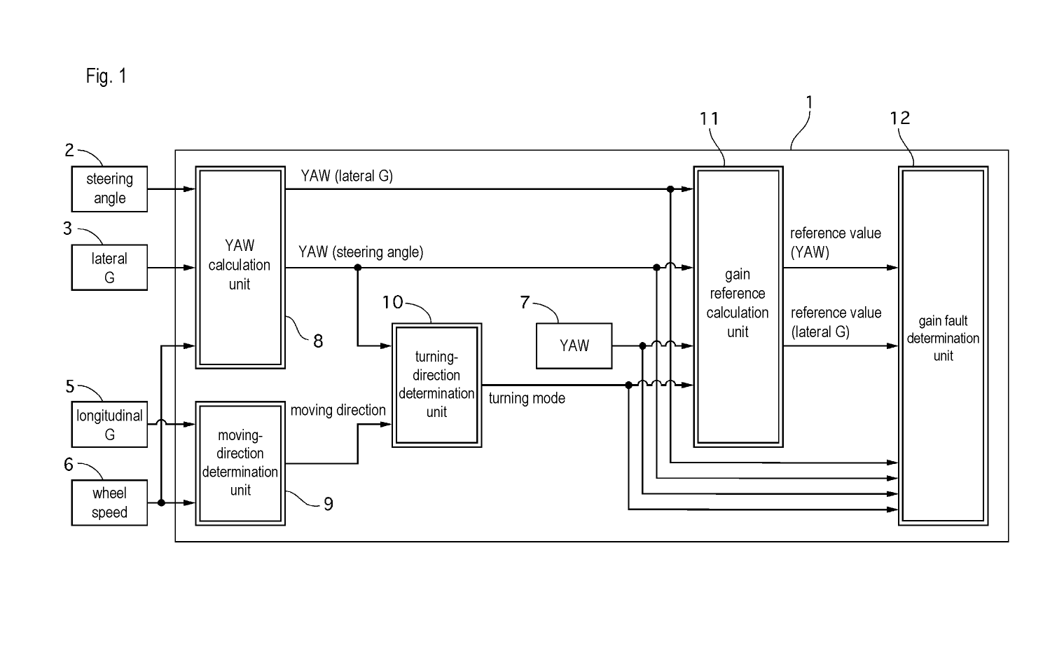

FIG. 1 is a block diagram of a gain fault determination processing unit 1. The gain fault determination processing unit 1 determines whether the grip of the tires of a moving vehicle is in a non-linear region, typically when the vehicle is turning on a road of low μ, or whether the vehicle is running on a bank. When the gripping force of the tires of the vehicle is in a non-linear region or when the vehicle is running on a bank, gain fault diagnosis of a lateral acceleration sensor 3 and a yaw rate sensor 7 is prohibited.

The gain fault determination processing unit 1 includes a yaw rate calculation unit 8, a moving-direction determination unit 9, a turning-direction determination unit 10, a gain reference calculation unit 11, and a gain fault determination unit 12.

<<Yaw Rate Calculation Unit>>

The yaw rate calculation unit 8 receives, for example, a steering angle of a steering wheel detected by a steering angle sensor 2, a lateral acceleration acting on the vehicle detected by the lateral acceleration sensor 3, and a vehicle body speed calculated from a value detected by a wheel speed sensor 6. A yaw rate acting on the vehicle (yaw rate calculated from steering is calculated from the steering angle and the vehicle body speed, and a yaw rate acting on the vehicle (yaw rate calculated from lateral acceleration) is calculated from the lateral acceleration.

<<Moving-Direction Determination Unit>>

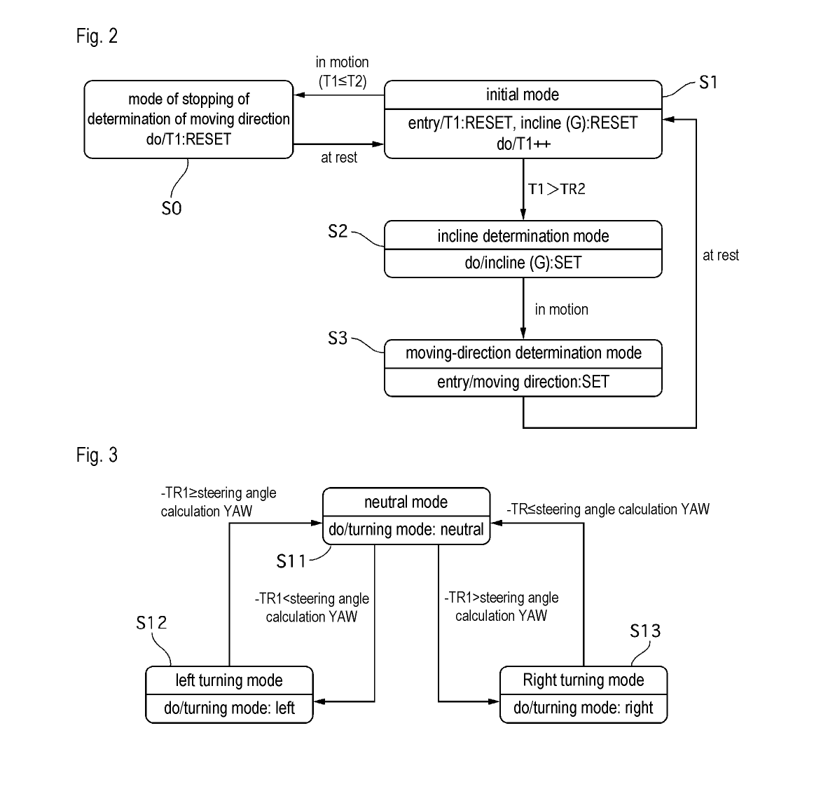

The moving-direction determination unit 9 receives, for example, a longitudinal acceleration acting on the vehicle from a longitudinal-acceleration sensor 5 and a vehicle wheel speed from the wheel speed sensor 6. FIG. 2 is a state transition diagram of the moving-direction determination unit 9. When the vehicle is at rest, the moving-direction determination unit 9 proceeds from state S0 to state S1. In the state S1, the moving-direction determination unit 9 resets variables when the vehicle is at rest, and determines whether the vehicle is stably at rest. A time T1 for determination of permissibility of diagnosis and an acceleration on incline are also reset. The determination time T1 for determination of permissibility of diagnosis is incremented.

When the determination time T1 for determination of permissibility of diagnosis exceeds a stop threshold TR2, the process proceeds to state S2. The stop threshold TR2 is set to a length of time sufficient to allow vibrations of vehicle to subside after the vehicle has come to a stop.

State S2 determines the gradient of a road surface. The longitudinal acceleration of the vehicle at rest is stored as an acceleration on incline. When the determination time T1 for determination of permissibility of diagnosis is lower than the stop threshold TR2, the process proceeds to state S0. When the vehicle starts moving, the process proceeds to state S3. The state S3 determines the direction of motion of the vehicle. The longitudinal acceleration acting on the vehicle while moving is used to determine the direction of motion.

<<Turning-Direction Determination Unit>>

The turning-direction determination unit 10 receives a yaw rate calculated from steering angle from the yaw rate calculation unit 8 and data on direction of motion from the moving-direction determination unit 9. FIG. 3 is a state transition diagram of the turning-direction determination unit 10.

When the yaw rate calculated from steering angle is lower than or equal to a turning-direction threshold TR1 and greater than or equal to a turning-direction threshold −TR1, the process proceeds to state S11. The state S11 records the turning mode as “neutral.”

When the yaw rate calculated from steering angle drops below the turning-direction threshold −TR1, the process proceeds to state S12. The state S12 records the turning mode as “left.” If the yaw rate calculated from steering angle exceeds the turning-direction threshold TR1 while the vehicle is moving backward, the process proceeds to the state 12.

When the yaw rate calculated from steering angle exceeds the turning-direction threshold TR1, the process proceeds to state S13. The state S13 records the turning mode as “right.” When the yaw rate calculated from steering angle drops below the turning direction threshold −TR1 while the vehicle is moving backward, the process proceeds to the state S12.

The turning-direction threshold TR1 is set to a yaw rate sufficient to ensure that the turning direction of the vehicle changes. If the turning-direction threshold TR1 were too small, there would be a likelihood of detecting the turning direction of the vehicle incorrectly. If the turning-direction threshold TR1 were too large, a possible range of gain fault processing, which will be described later, would become narrow.

<<Gain Reference Calculation Unit>>

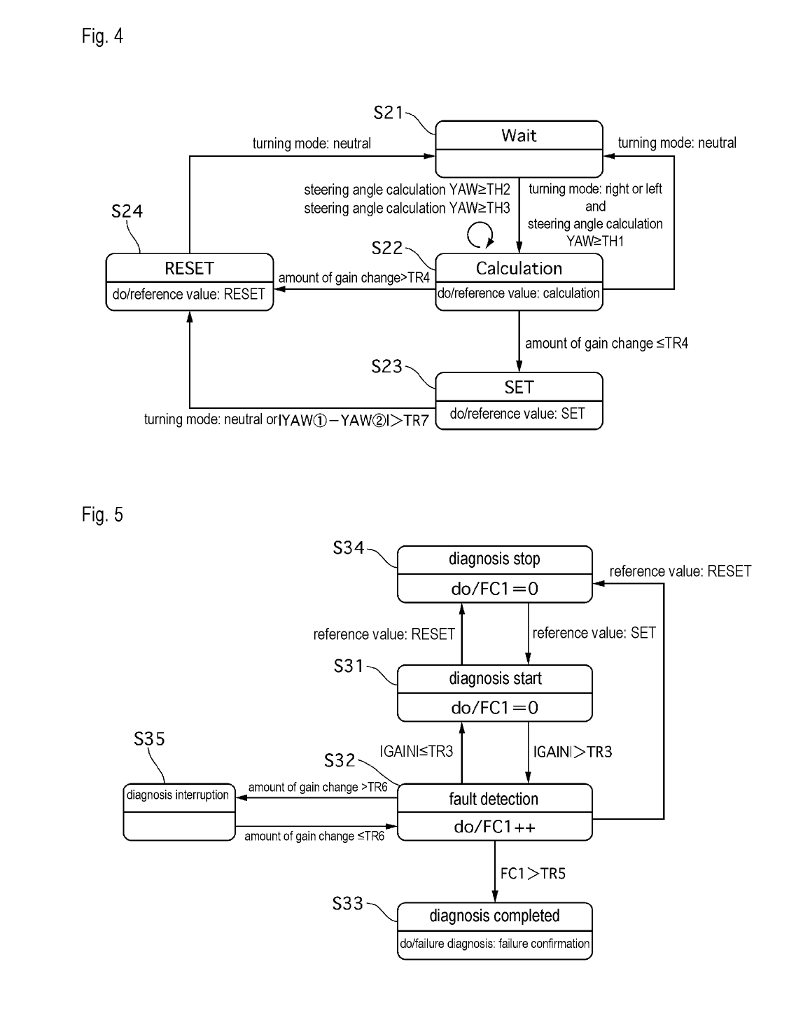

The gain reference calculation unit 11 receives a yaw rate calculated from steering angle and a yaw rate calculated from lateral acceleration from the yaw rate calculation unit 8, a turning mode from the turning-direction determination unit 10, and a yaw rate (yaw rate detected) detected by the yaw rate sensor 7. FIG. 4 is a state transition diagram of the gain reference calculation unit 11. When the turning mode is “neutral,” the process proceeds to state S21. In the state 21, the gain reference calculation unit 11 stands by until the turning mode becomes “right” or “left.” When the turning mode becomes “left” or “right” and e yaw rate calculated from steering angle reaches a first threshold TH1 or greater, the process proceeds to state 22. In the state 22, the gain reference calculation unit 11 takes a sample value when the yaw rate calculated from steering angle reaches the first threshold TH1 or greater. This sample value is referred to as a first sample value. The gain reference calculation unit 11 stands by until the yaw rate calculated from steering angle reaches a second threshold TH2 or greater, the second threshold TH2 being greater than the first threshold TH1. When the yaw rate calculated from steering angle reaches the second threshold TH2 or greater, the gain reference calculation unit 11 takes another sample value. This sample value is referred to as a second sample value. The gain reference calculation unit 11 stands by until the yaw rate calculated from steering angle reaches a third threshold TH3 or greater, the third threshold TH3 being greater than the second threshold TH2. When the yaw rate calculated from steering angle reaches the third threshold TH3 or greater, the gain reference calculation unit 11 takes another sample value. This sample value is referred to as a third sample value.

When a change from the ratio (gain) of the second sample value to the first sample value to the ratio (gain) of the third sample value to the second sample value is lower than or equal to a threshold TR4 for stopping gain reference calculation, the third sample value is calculated as a reference value. Thereafter, the process proceeds to state S23. The state S23 sets a calculated reference value. When a change from the ratio (gain) of the second sample value to the first sample value to the ratio (gain) of the third sample value to the second sample value is greater than the threshold TR4 for stopping gain reference calculation, the process proceeds to state S24.

Even when the grip of the tires of the vehicle while turning is in a linear region, the gain of two sample values changes to some extent. The threshold TR4 for stopping gain reference calculation is set to a value that permits a gain change when the grip of the tires of the vehicle while turning is in a linear region. The state 24 resets the reference value.

When the turning mode becomes “neutral” after the process proceeds to state S23, the process proceeds to the state 24. When the absolute value of the difference between a comparison signal YAW1 and a comparison signal YAW2 is greater than a correlation failure threshold TR7 after the process proceeds to the state 23, the process proceeds to the state S24. The comparison signals YAW1 and YAW2 may represent two parameters selected from among the yaw rate calculated from steering angle, and yaw rate calculated from lateral acceleration, and the yaw rate detected.

When the turning mode becomes “neutral” after the process proceeds to the state S24, the process goes to state S21.

<<Gain Fault Determination Unit>>

The gain fault determination unit 12 receives a yaw rate calculated from steering angle and a yaw rate calculated from lateral acceleration from the yaw rate calculation unit 8, a reference value from the gain reference calculation unit 11, a turning mode from the turning-direction determination unit 10, and a yaw rate detected by the yaw rate sensor 7. FIG. 5 is a state transition diagram of the gain fault determination unit 12.

Once the reference value is set, the process proceeds to state S31. The state S31 sets a fault determination time FC1 to “zero.” When the absolute value of the gain of the yaw rate detected relative to the reference value or the absolute value of the gain of the yaw rate calculated from lateral acceleration relative to the reference value is greater than a fault determination threshold TR3, the process proceeds state S32. The state S32 increments the fault determination time FC1.

When the absolute value the gain of the yaw rate detected relative to the reference value or the absolute value of the gain of the yaw rate calculated from lateral acceleration relative to the reference value is lower than or equal to the fault determination threshold TR3 after the process goes to the state S32, the process returns to state S31.

The fault determination threshold TR3 may be set to a value that prevents an incorrect detection in which the absolute value of the gain of the yaw rate detected relative to the reference value or the absolute value of the gain of the yaw rate calculated from lateral acceleration relative to the reference value is lower than or equal to the fault determination threshold TR3 when the grip of the tires of the vehicle while turning is in a linear region.

When the fault determination time FC1 exceeds a fault confirmation threshold TR5, the process goes to state S33. The state S33 confirms that the lateral acceleration sensor 3 or the yaw rate sensor 7 is failing and terminates the diagnosis.

When the reference value is reset after the process proceeds to state S32, the process goes to state S34. The state S34 sets the fault determination time FC1 to “zero.”

When an amount of change in the gain of the yaw rate detected relative to the reference value or an amount of change in the gain of the yaw rate calculated from lateral acceleration relative to the reference value is greater than a diagnosis stopping threshold TR6, the process goes to state S35. The state S35 interrupts output-gain fault diagnosis. When the amount of change in the gain of the yaw rate detected relative to the reference value or the amount of change in the gain of the yaw rate calculated from lateral acceleration relative to the reference value reaches the diagnosis stopping threshold TR6 or less, the process returns to state S32.

Even when the grip of the tires of the vehicle while turning is within a linear region, the gain of the yaw rate detected relative to the reference value changes to some extent. Similarly, the gain of the yaw rate calculated from the lateral acceleration relative to the reference value changes to some extent. The diagnosis interruption threshold TR6 is set to a value that permits a gain change when the grip of the tires of the vehicle while turning is in a linear region. The diagnosis stopping threshold TR6 may be set equal to or slightly greater than the above-described gain reference calculation stopping threshold TR4.

<<Effect>>

When the vehicle is traveling on a road of low μ or a bank, the correlation of values detected by the steering angle sensor 2, the lateral acceleration sensor 3, and the yaw rate sensor 7 becomes negative. Such a road of low μ has a low friction coefficient between the tires and the road surface. For this reason, even with a large steering angle, a lateral acceleration and a yaw rate detected may be underestimated. On the other hand, gravity acts in the lateral direction of the vehicle on a bank. This may result in overestimation of a lateral acceleration and a yaw rate, even with a small steering angle. In other words, inspection of sensors for any faults based on whether there is a correlation between values detected by the sensors may lead to determination of the sensors as failing even though they are functioning normally.

Whether or not a vehicle is moving stably (or whether it is travelling on a road of high p or a non-bank road) can be determined from the relationship between tire slip angle and vehicle speed. The stability can also be determined from the relationship between lateral acceleration and vehicle speed. Such determination, however, cannot be made when a sensor outputting a detection value is failing. The determination based on tire slip angle, for example, requires a steering angle. Such determination cannot be made if the steering angle sensor 2 failing. The determination based on lateral acceleration cannot be made if the lateral acceleration sensor 3 is failing.

In view of the foregoing, in the first embodiment, when an amount of change in the gain of a yaw rate detected relative to a yaw rate calculated from steering angle is lower than or equal to a predetermined value or when an amount of change in the gain of a yaw rate calculated from lateral acceleration relative to a yaw rate calculated from steering angle is lower than or equal to a predetermined value, the output gain of the sensor is inspected for any fault.

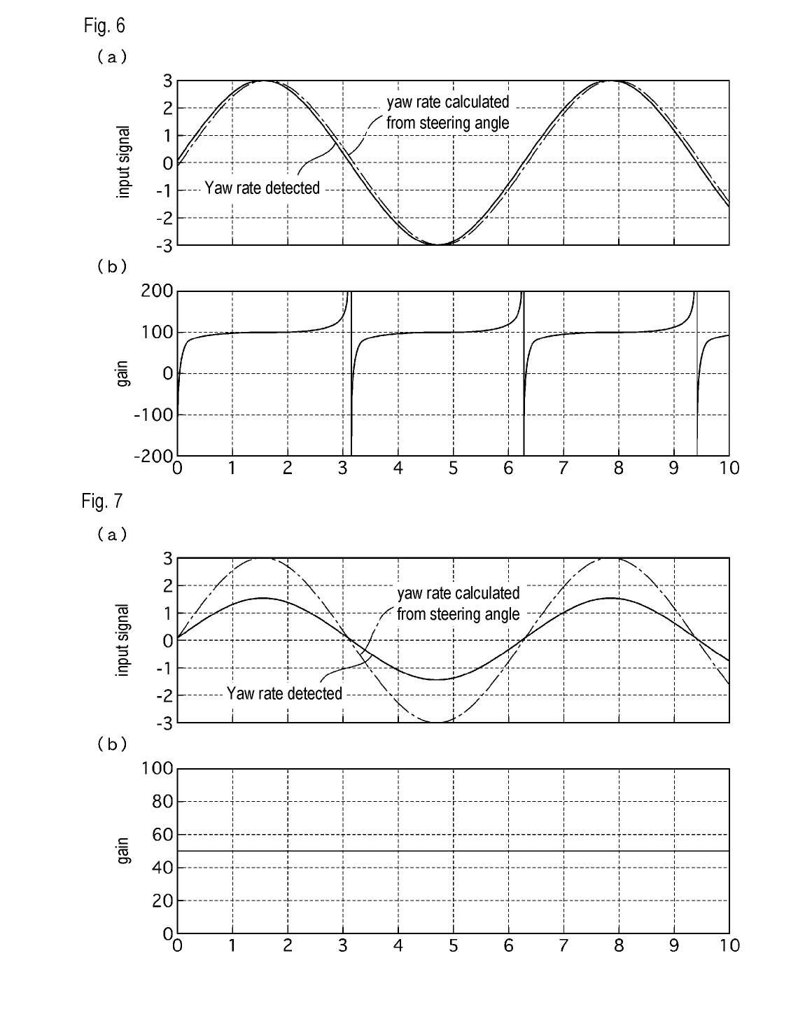

FIGS. 6 and 7 are time charts (FIGS. 6(a) and 7(a)) of yaw rate calculated from steering angle and yaw rate detected and time charts (FIGS. 6(b) and 7(b)) of gain of yaw rate detected relative to yaw rate calculated from steering angle. FIG. 6 shows that the yaw rate calculated from steering angle and a yaw rate detected are out of phase, owing to the grip of the tires of the vehicle when turning being in a non-linear region, even though the yaw rate sensor 7 is functioning normally. FIG. 7 shows that while the grip of the tires of the vehicle while turning is in a linear region, the output gain of the yaw-rate sensor 7 indicates a fault.

When the grip of the tires of the vehicle while turning is in a non-linear region, the yaw rate detected goes out of phase with the yaw rate calculated from steering angle. For this reason, the gain of the yaw rate detected relative to the yaw rate calculated from steering angle varies constantly (FIG. 6). On the other hand, when the output gain of the yaw rate sensor 7 indicates a fault while the grip of the tires during a vehicle turn is in a linear region, the yaw rate detected hardly goes out of phase with the yaw rate calculated from steering angle. As such, the gain of the yaw rate detected relative to the yaw rate calculated from steering angle remains, though reduced, generally constant (FIG. 7).

Therefore, the running state of the vehicle can be determined by taking the amount of change in gain into account, regardless of the level of the gain. A large change in gain can be determined as the vehicle making a turn when the grip the tires is in a non-linear region. At this time, diagnosis of output gain fault in the yaw rate sensor 7 or lateral acceleration sensor 3 is prohibited. This prevents incorrect detection of a fault in the sensors in the output fault diagnosis.

Whether or not the vehicle is making a turn when the grip of the tires is in a non-linear region can be also determined from the difference between yaw rate calculated from steering angle and yaw rate detected or between yaw rate calculated from steering angle and yaw rate calculated from lateral acceleration. Below, comparison is made between the difference-based determination to prohibit diagnosis of output gain fault and the gain-based determination to prohibit diagnosis of output gain fault.

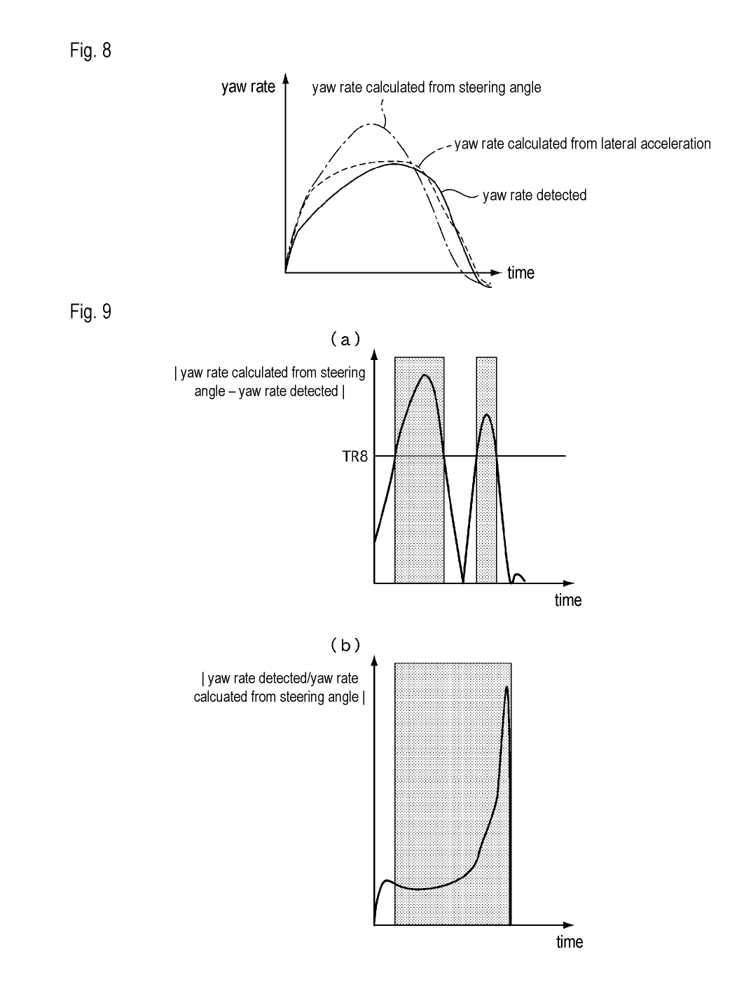

FIG. 8 is a time chart of yaw rate calculated from steering angle, yaw rate detected, and yaw rate calculated from lateral acceleration. FIG. 8 shows the state of the vehicle making a turn on a road of low μ.

Immediately after the vehicle starts turning, the yaw rate calculated from lateral acceleration takes values close to the yaw rate calculated from steering angle and then gradually levels off. Compared with the yaw rate calculated from lateral acceleration, the yaw rate detected deviates early from the yaw rate calculated from steering angle.

When the steering wheel is turned the opposite direction, the tire grip tends to recover. However, the yaw rate calculated from lateral acceleration and yaw rate detected vary, following but lagging behind the yaw rate calculated from steering angle.

FIG. 9 is a graph of changes in yaw rate detected relative to yaw rate calculated from steering angle. FIG. 9(a) is a graph of the absolute value of the difference between yaw rate calculated from steering angle and yaw rate detected. FIG. 9(b) is a graph of the absolute value of the gain of the yaw rate detected relative to yaw rate calculated from steering angle. The hatched areas in FIG. 9 indicate prohibition of diagnosis of output gain fault.

The difference-based prohibition of diagnosis of output gain fault is made in ranges where the absolute value of the difference is greater than or equal to the diagnosis interruption threshold TR8.

As described above, when the vehicle is turning on a road of low μ, the yaw rate detected lags behind the yaw rate calculated from steering angle earlier than the yaw rate calculated from lateral acceleration does. As such, the difference increases rapidly, making it possible to prohibit diagnosis of output gain fault relatively early. When the steering angle starts decreasing, the absolute value of the difference between yaw rate calculated from steering angle and yaw rate detected drops temporarily at some point in time. This causes the absolute value of the difference between yaw rate calculated from steering angle and yaw rate detected to drop below the diagnosis interruption threshold TR8, resulting in prematurely ending the prohibition of diagnosis of output gain fault.

When the vehicle is turning on a road of low μ, the yaw rate calculated from steering angle and the yaw rate detected are out of phase, causing constant changes in gain. As such, when the vehicle is turning on a road of low μ, diagnosis of output gain fault can be prohibited at any time.

In FIG. 9(b), diagnosis of output gain fault is prohibited when the absolute value of the gain starts dropping after it has temporarily risen. This is because three values of yaw rate calculated from steering angle are taken as samples in the state S22 of FIG. 4. During this term, diagnosis of output gain fault is not prohibited; however, since no reference value is set, diagnosis of output gain fault actually does not take place.

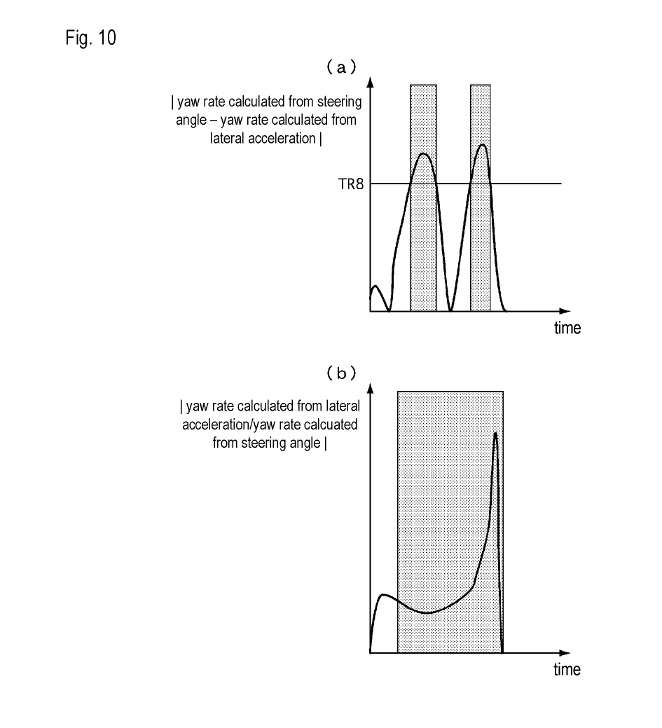

FIG. 10 is a graph of changes in yaw rate calculated from lateral acceleration relative to yaw rate calculated from steering angle. FIG. 10(a) is a graph of the absolute value of the difference between yaw rate calculated from steering angle and yaw rate calculated from lateral acceleration. FIG. 10(b) is a graph of the absolute value of the gain of yaw rate calculated from lateral acceleration relative to yaw rate calculated from steering angle. The hatched areas in FIG. 10 indicate prohibition of diagnosis of output gain fault.

As described earlier, immediately after the vehicle starts turning on a road of low μ, the yaw rate calculated from lateral acceleration takes values near the yaw rate calculated from steering angle and then gradually levels off. For this reason, the difference increases slowly, causing a delay in prohibition of diagnosis of output gain fault. When the steering angle starts decreasing, the absolute value of the difference between yaw rate calculated from steering angle and yaw rate calculated from lateral acceleration drops temporarily at some point in time. This causes the absolute value of the difference between yaw rate calculated from steering angle and yaw rate calculated from lateral acceleration to drop below the diagnosis interruption threshold TR8, resulting in prematurely ending the prohibition of diagnosis of output gain fault.

When the vehicle is turning on a road of low μ, the yaw rate calculated from steering angle and the yaw rate detected are out of phase, causing a change in gain immediately after the turn. As such, diagnosis of output gain fault can be prohibited immediately after the vehicle makes a turn on the road of low μ. When the vehicle is making a turn on a road of low μ, the gains of the yaw rate calculated from steering angle and the yaw rate calculated from lateral acceleration vary constantly. For this reason, when the vehicle is turning on a road of low μ, diagnosis of output gain fault can be prohibited at any time.

As described above, the state in which the yaw rate calculated from steering angle and the yaw rate detected go out of phase occurs even when the vehicle is not running on a bank. Similarly, the state in which the yaw rate calculated from steering angle and the yaw rate calculated from lateral acceleration go out of phase occurs even when the vehicle is not running on a bank.

The first embodiment detects any faults in gains of outputs of the yaw-rate sensor 7 and lateral-acceleration sensor 3 while the vehicle is making a turn.

Such turning of the vehicle is a suitable condition for diagnosis, since the output values of yaw rate detected, yaw rate calculated from lateral acceleration, and yaw rate calculated from steering angle are large.

In detecting any fault in output gain, the first embodiment uses a yaw rate calculated from steering angle during vehicle turn as a reference value for comparison with yaw rate detected or yaw rate calculated from lateral acceleration.

The steering angle sensor 2 is more reliable than the yaw rate sensor 7 and the lateral acceleration sensor 3. Use of the yaw rate calculated from a value detected by the reliable steering angle senor 2 as a reference value increases accuracy in the detection of any fault in the gain of output of yaw rate detected or yaw rate calculated from lateral acceleration.

The first embodiment determines a gain of yaw rate detected relative to the reference value of yaw rate calculated from steering angle, as a fault in the gain of the output from the yaw rate sensor 7, when the gain is greater than or equal to a predetermined value or lower than or equal to a predetermined value. The first embodiment also determines a gain of yaw rate calculated from lateral acceleration relative to the reference value of yaw rate calculated from steering angle, as a fault in the gain of the output from the lateral acceleration sensor 3, when the gain is greater than equal to a predetermined value or lower than or equal to a predetermined value.

When a fault occurs in the gain of the output from the yaw rate sensor 7, the value of yaw rate detected is higher or lower than the reference value. Similarly, when a fault occurs the gain of the output from the lateral acceleration sensor 3, the value of yaw rate detected is higher or lower than the reference value. This enables detection of a fault in the gain of sensor output with a simple technique.

In the first embodiment, a mode of detecting any fault in output gain is corrected in accordance with the direction of motion of the vehicle detected by the moving-direction determination unit 9.

The yaw rate when the vehicle is moving ahead acts in the opposite direction to that when it is moving back. For example, when the vehicle is steered to the left while moving ahead, the yaw rate acts in the left turning direction. When the vehicle is moving back, the yaw rate acts in the right turning direction. This phenomenon enables detection of output fault, regardless of the direction of motion of the vehicle.

<<Effect>>

(1) The vehicle control apparatus includes: the steering angle sensor 2 that detects a steering angle proportional to operation of the steering wheel of the vehicle; the yaw rate sensor 7 that detects a yaw rate acting on the vehicle; and the gain fault determination unit 12 (unit for detection of gain of fault in yaw rate sensor output), which determines detection of any fault in the gain of output of the yaw rate sensor 7 as possible if an amount of change in the gain of a yaw rate detected by the yaw rate sensor 7 relative to a yaw rate calculated from a steering angle detected by the steering angle sensor 2 is lower than or equal to a predetermined value, and detects any fault in the gain of the output of the yaw rate senor 7 if the detection of any fault in the gain of the output of the yaw rate sensor 7 is determined as possible.

In this way, the detection of any fault in the gain of output of the yaw rate sensor 7 can be made when the vehicle is moving while the grip of the tires is in a linear region. This makes it possible to prevent incorrect detection of a fault in the gain of output of the yaw rate sensor 7.

(2) The vehicle control apparatus further includes the turning-direction determination unit 10 that determines whether the vehicle is making a turn. The gain fault determination unit 12 detects any fault in the gain of the output of the yaw rate sensor 7 if the turning-direction determination unit 10 determines the vehicle as making a turn.

This makes it possible to prevent incorrect detection of a fault in the gain of output of the yaw rate sensor 7.

(3) The gain fault determination unit 12 sets a value of the yaw rate calculated from steering angle during vehicle turn as a reference value for comparison with yaw rate detected.

This makes it possible to increase accuracy in detection of any fault in the gain of output of the yaw rate sensor 7.

(4) The gain fault determination unit 12 detects any fault in the gain of output of the yaw rate sensor 7 if the gain of the yaw rate detected relative to the reference value during vehicle turn is greater than or equal to a predetermined value or lower than or equal to a predetermined value.

This enables detection of any fault in the gain of output of the yaw rate sensor 7 with a simple technique.

(5) The vehicle control apparatus further includes the moving-direction determination unit 9 (longitudinal-movement detection unit) that detects the direction of the vehicle's longitudinal movement. The gain fault determination unit 12 corrects the mode of detecting any fault in output gain in accordance with the direction of longitudinal movement detected.

This enables accurate detection of any fault in the gain of the output of the yaw rate sensor regardless of the direction of the vehicle's longitudinal movement.

(6) The vehicle control apparatus includes: the lateral acceleration sensor 3 that detects the lateral acceleration of the vehicle; and the gain fault determination unit 12 (unit for detection of fault in gain of output of lateral acceleration sensor), which determines detection of any fault in the gain of the output of the lateral acceleration sensor 3 as possible if an amount of change in the gain of the yaw rate calculated from the lateral acceleration detected by the lateral acceleration sensor relative to the yaw rate calculated from steering angle is lower than or equal to a predetermined value, and carries out a process of detecting any fault in the gain of the output of the lateral acceleration sensor 3 if the detection of any fault in the gain of the output of the lateral acceleration sensor 3 is determined as possible.

This enables detection of a fault in the gain of output of the lateral acceleration sensor 3 with a simple technique.

(7) The gain fault determination unit 12 sets a value of the yaw rate calculated from steering angle during vehicle turn as a reference value for comparison with the yaw rate calculated from lateral acceleration.

This makes it possible to enhance the accuracy in detection of any fault in the gain of output of the lateral acceleration sensor 3.

(8) The gain fault determination unit 12 detects any fault in the gain of output of the lateral acceleration sensor 3 if the gain of the yaw rate calculated from lateral acceleration relative to the reference value is greater than or equal to a predetermined value or lower than or equal to a predetermined value.

This enables detection of a fault in the gain of output of the lateral acceleration sensor 3 with a simple technique.

(9) The vehicle control apparatus includes: the steering angle sensor 2 that detects a steering angle proportional to operation of the steering wheel of the vehicle; the lateral acceleration sensor 3 that detects a lateral acceleration acting on the vehicle; the yaw rate sensor 7 that detects a yaw rate acting on the vehicle; and the gain fault determination unit 12 (detection determination unit, unit for detection of output gain fault). The gain fault determination unit 12 determines detection of any fault in the gain of output of the yaw rate sensor 7 as possible if an amount of change in the gain of the yaw rate detected by the yaw rate sensor 7 relative to the yaw rate calculated from the steering angle detected by the steering angle sensor 2 during vehicle turn is lower than or equal to a predetermined value. The gain fault determination unit 12 determines detection of any fault in the gain of output of the lateral acceleration sensor 3 as possible if an amount of change in the gain of the yaw rate calculated from the lateral acceleration detected by the lateral acceleration sensor 3 relative to the yaw rate calculated from steering angle during vehicle turn is lower than or equal to a predetermined value. The gain fault determination unit 12 detects any fault in the gain of output of the yaw rate senor if the detection of any fault in the gain of output of the yaw rate sensor is determined as possible. The gain fault determination unit 12 detects any fault in the gain of output of the lateral acceleration sensor if the detection of any fault in the gain of output of the lateral acceleration sensor is determined as possible.

This enables detection of any fault in the gain of the output of the yaw rate sensor 7 or lateral acceleration sensor 3 when the vehicle is moving with the grip of the tires in a linear region. This makes it possible to prevent incorrect detection of a fault in the gain of output of the yaw rate 7 or lateral acceleration sensor 3.

(10) The gain fault determination unit 12 sets a value of the yaw rate calculated from steering angle during vehicle turn as a first reference value for comparison with the yaw rate detected, and a value of the yaw rate calculated from steering angle as a second reference value for comparison with the yaw rate calculated from lateral acceleration.

This makes it possible to increase the accuracy in the detection of any fault in the gain of output of the yaw rate sensor 7 or lateral acceleration sensor 3.

(11) The gain fault determination unit 12 detects any fault in the gain of output of the yaw rate sensor if the gain of the yaw rate detected relative to the first reference value is greater than or equal to a predetermined value or lower than or equal to a predetermined value while the vehicle is making turn, and detects any fault in the gain of output of the lateral acceleration sensor if the gain of the yaw rate calculated from lateral acceleration relative to the second reference value is greater than or equal to a predetermined value or lower than or equal to a predetermined value while the vehicle is making a turn.

This enables detection of a fault in the gain of output of the yaw rate sensor 7 or lateral acceleration sensor 3 with a simple technique.

(12) The vehicle control apparatus further includes the moving-direction determination unit 9 (longitudinal movement detection unit) that detects the direction of the vehicle's longitudinal movement, and the gain fault determination unit 12 corrects a mode of detecting any fault in output gain in accordance with the direction of longitudinal movement detected.

This enables accurate detection of any fault in the gain of the output of the yaw rate sensor 7, regardless of the direction of the vehicle's longitudinal movement.

(13) The vehicle control apparatus includes: the steering angle sensor 2 that detects a steering angle proportional to operation of the steering wheel of the vehicle; the yaw rate sensor 7 that detects a yaw rate acting on the vehicle; and the gain fault determination unit 12 (unit for detection of fault in yaw rate sensor output gain), which calculates a yaw rate from a steering angle detected by the steering angle sensor 2 during vehicle turn, sets the yaw rate calculated, as a reference value, and calculates a an amount of change in a ratio of the yaw rate detected by the yaw rate sensor 7 to the reference value and to detect any fault in the output gain of the yaw rate sensor 7 if the amount of change is lower than and equal to a predetermined value.

This enables detection of any fault in the gain of the output of the yaw rate sensor 7 when the vehicle is moving with the grip of the tires in a linear region. This makes it possible to prevent incorrect detection of a fault in the gain of output of the yaw rate sensor 7.

(14) The vehicle control apparatus further includes the lateral acceleration sensor 3 that detects lateral acceleration acting on the vehicle; and the gain fault determination unit 12 (unit for detection of lateral acceleration output gain), which calculates an amount of change in a ratio of a yaw rate calculated from a lateral acceleration detected by the lateral acceleration sensor 3 to a reference value, and detects any fault in the gain of output of the lateral acceleration sensor 3 if the amount of change is lower than or equal to a predetermined value.

This enables detection of any fault in the gain of output of the lateral acceleration sensor 3 when the vehicle is moving with the grip of the tires in a linear region. This makes it possible to prevent incorrect detection of a fault in the gain of output of the lateral acceleration sensor 3.

(15) The gain fault determination unit 12 detects any fault in the gain of output of the yaw rate sensor if a ratio of a yaw rate detected to a reference value is greater than or equal to a predetermined value or lower than or equal to a predetermined value.

This enables detection of a fault in the gain of output of the yaw rate sensor 7 with a simple technique.

(16) The gain fault determination unit 12 detects any fault in the gain of output of the lateral acceleration sensor if a ratio of a yaw rate calculated from lateral acceleration to a reference value is greater than or equal to a predetermined value or lower than or equal to a predetermined value.

This enables detection of a fault in the output gain of the lateral acceleration sensor 3 with a simple technique.

(17) The vehicle control apparatus further includes the moving-direction determination unit 9 (longitudinal movement detection unit) that detects the direction of the vehicle's longitudinal movement. The gain fault determination unit 12 corrects a mode of detecting any fault in the gain of output of the yaw rate sensor 7 in accordance with the direction of longitudinal movement detected.

This enables accurate detection of any fault in the gain of output of the yaw rate sensor 7 or lateral acceleration sensor 3, regardless of the vehicle's moving direction.

### Other Embodiments

Although the present invention is described in terms of the first embodiment above, the structural details of each invention are nevertheless not intended to be limited to the first embodiment; various design modifications may be made without departing from the spirit of the invention.

The first embodiment uses a yaw rate calculated from steering angle as a reference value in detecting any fault in sensor output gain. The reference value, however, may be, instead, a yaw rate calculated from wheel speed. It is therefore possible to set an extra reference value. This permits detection of fault in the gain of output of the yaw rate sensor 7 or lateral acceleration sensor 3 to continue even when ether the steering angle sensor 2 or wheel speed sensor 6 fails.

In the first embodiment, diagnosis of any fault in the gain of output of the yaw rate sensor 7 or lateral acceleration sensor 3 is stopped when an amount of change in the gain of the yaw rate detected or the yaw rate calculated from lateral acceleration, relative to a reference value is larger than a diagnosis stopping threshold TR6. In addition to the amount of gain change, a gradient of gain change can be used in such a manner that the diagnosis of any fault in the gain of output of the yaw rate sensor 7 or the lateral acceleration sensor 3 is stopped when the gradient of gain change is greater than a predetermined value.

Some vehicles by their own nature yield a relatively large change in the gain of the yaw rate detected or the yaw rate calculated from lateral acceleration relative to a reference value even when the vehicle is making a turn with the grip of the tires in a linear region. Such vehicles require a relatively high diagnosis stopping threshold TR6. This relatively high diagnosis stopping threshold TR6 may cause a delay in stopping diagnosis of output gain fault. However, the diagnosis of output gain fault can be stopped at an earlier stage by stopping the diagnosis of any fault in the gain of output of the yaw rate sensor 7 or the lateral acceleration sensor 3 when the gradient of gain change is greater than a predetermined value.

1. A vehicle control apparatus comprising:
a steering angle sensor configured to detect a steering angle proportional to operation of a steering wheel of a vehicle;
a yaw rate sensor configured to detect a yaw rate acting on the vehicle;
a unit for detection of fault in gain of yaw rate sensor output configured to determine detection of any fault in a gain of output of the yaw rate sensor as possible if an amount of change in the gain of a yaw rate detected by the yaw rate sensor relative to a yaw rate calculated from a steering angle detected by the steering angle sensor is lower than or equal to a predetermined value, and to detect any fault in the gain of output of the yaw rate sensor if the detection of any fault in the gain of output of the yaw rate sensor is determined as possible.

2. The vehicle control apparatus according to claim 1, further comprising a turning-direction determination unit configured to determine whether the vehicle is making a turn, wherein if the turning-direction determination unit determines that the vehicle is making a turn, the unit for detection of fault in gain of yaw rate sensor output detects any fault in the gain of output of the yaw rate sensor.

3. The vehicle control apparatus according to claim 2, wherein the unit for detection of fault in gain of yaw rate sensor output is configured to set a value of the yaw rate calculated from steering angle when the vehicle is making a turn, as a reference value for comparison with the yaw rate detected.

4. The vehicle control apparatus according to claim 3, wherein the unit for detect on of fault in gain of yaw rate sensor output is configured to detect any fault in the gain of output of the yaw rate sensor if the gain of the yaw rate detected relative to the reference value while the vehicle is making a turn is greater than or equal to a predetermined value or lower than or equal to a predetermined value.

5. The vehicle control apparatus according to claim 2, further comprising a longitudinal-movement detection unit configured to detect a direction of the vehicle's longitudinal movement, wherein
the unit for detection of fault in gain of yaw rate sensor output comprises a unit for detection mode correction configured to correct a mode of detecting any fault in the output gain in accordance with the direction of longitudinal movement detected.

6. The vehicle control apparatus according to claim 2, further comprising: a lateral acceleration sensor configured to detect a lateral acceleration acting on the vehicle; and
a unit for detection of fault in lateral acceleration sensor output configured to determine detection of any fault in the gain of output of the lateral acceleration sensor as possible if an amount of change in the gain of a yaw rate calculated from a lateral acceleration detected by the lateral acceleration sensor relative to the yaw rate calculated from steering angle is lower than or equal to a predetermined value, and to detect any fault in the gain of output of the lateral acceleration sensor if the detection of any fault in the gain of output of the lateral acceleration sensor is determined as possible.

7. The vehicle control apparatus according to claim 6, wherein the unit for detection of fault in lateral acceleration sensor output is configured to set a value of the yaw rate calculated from steering angle during the vehicle's turn as a reference value for comparison with the yaw rate calculated from lateral acceleration.

8. The vehicle control apparatus according to claim 7, wherein the unit for detection of fault in lateral acceleration senor output is configured to detect any fault in the gain of output of the lateral acceleration sensor if the gain of the yaw rate calculated from lateral acceleration relative to the reference value is greater than or equal to a predetermined value or lower than or equal to a predetermined value.

9. A vehicle control apparatus comprising:
a steering angle sensor configured to detect a steering angle proportional to operation of a steering wheel of a vehicle;
a lateral acceleration sensor configured to detect a lateral acceleration acting on the vehicle;
a yaw rate sensor configured to detect a yaw rate acting on the vehicle;
a detection determination unit configured to determine detection of any fault in the gain of output of the yaw rate sensor as possible if an amount of change in the gain of a yaw rate detected by the yaw rate sensor, relative to a yaw rate calculated from the steering angle detected by the steering angle sensor during vehicle turn, is lower than or equal to a predetermined value, and to determine detection of any fault in the gain of output of the lateral acceleration sensor as possible if an amount of change in the gain of a yaw rate calculated from the lateral acceleration detected by the lateral acceleration sensor relative to the yaw rate calculated from steering angle during vehicle turn is lower than or equal to a predetermined value; and
an unit for detection of output gain fault configured to detect any fault in the gain of output of the yaw rate sensor if determining the detection of any fault in the gain of output of the yaw rate sensor as possible, and to carry out a process of the detecting any fault in the gain of output of the lateral acceleration sensor if determining the detection of any fault in the gain of output of the lateral acceleration sensor as possible.

10. The vehicle control apparatus according to claim 9, wherein the unit for detection of output gain fault is configured to set a value of the yaw rate calculated from steering angle during the vehicle turn as a first reference value for comparison with the yaw rate detected, and a value of the yaw rate calculated from steering angle as a second reference value for comparison with the yaw rate calculated from lateral acceleration.

11. The vehicle control apparatus according to claim 9, wherein the unit for detection of output gain fault is configured to detect any fault in the gain of output of the yaw rate sensor if the gain of the yaw rate detected relative to the first reference value during the vehicle turn is greater than or equal to a predetermined value or lower than or equal to a predetermined value, and to detect any fault in the gain of output of the lateral acceleration sensor if the gain of the yaw rate calculated from lateral acceleration relative to the second reference value during the vehicle turn is greater than or equal to a predetermined value or lower than or equal to a predetermined value.

12. The vehicle control apparatus according to claim 9, further comprising a longitudinal-movement detection unit configured to detect a direction of the vehicle's longitudinal movement, wherein
the unit for detection of output gain fault comprises a unit for detection mode correction configured to correct a mode of detecting any fault the output gain in accordance with the direction of longitudinal movement detected.

13. A vehicle control apparatus comprising:
a steering angle sensor configured to detect a steering angle proportional to operation of a steering wheel of a vehicle;
a yaw rate sensor configured to detect a yaw rate acting on the vehicle;
a unit for detection of fault in gain of yaw rate sensor output configured, during vehicle turn, to calculate a yaw rate from the steering angle detected by the steering angle sensor, use the yaw rate calculated from steering angle as a reference value, calculate an amount of change in a ratio between the reference value and the yaw rate detected by the yaw rate sensor, and detect any fault in the gain of output of the yaw rate sensor if the amount of change is lower than or equal to a predetermined value.

14. The vehicle control apparatus according to claim 13, further comprising:
a lateral acceleration sensor configured to detect a lateral acceleration acting on the vehicle; and
a unit for detection of fault in gain of lateral acceleration sensor output configured to calculate an amount of change in a ratio of a yaw rate calculated from the lateral acceleration detected by the lateral acceleration sensor, to the reference value and detect any fault in the gain of output of the lateral acceleration sensor if the amount of change is lower than or equal to a predetermined value.

15. The vehicle control apparatus according to claim 14, wherein the unit for detection of fault in gain of yaw rate sensor output is configured to detect any fault in the gain of output of the yaw rate sensor if a ratio of the yaw rate detected to the reference value is greater than or equal to a predetermined value or lower than or equal to a predetermined value.

16. The vehicle control apparatus according to claim 15, wherein the unit for detection of fault in gain of lateral acceleration sensor output is configured to detect any fault in the gain of output of the lateral acceleration sensor if a ratio of the yaw rate calculated from lateral acceleration to the reference value is greater than or equal to a predetermined value or lower than or equal to a predetermined value.

17. The vehicle control apparatus according to claim 16, further comprising a longitudinal-movement detection unit configured to detect a direction of the vehicle's longitudinal movement wherein
the unit for detection of fault in gain of yaw rate sensor output comprises a unit for detection mode correction configured to correct a mode of detecting any fault in the gain of output of the yaw rate sensor in accordance with the direction of longitudinal movement detected.
